(19) United States
(12) Patent Application Publication
(10) Pub. No.: US 2003/0195074 A1
(43) Pub. Date: Oct. 16, 2003

(54) Silent chain

(76) Inventors: Arimasa Kaga, Osaka (JP); Toshifumi Satoh, Osaka (JP)

Correspondence Address: HOWSON AND HOWSON, ONE SPRING HOUSE CORPORATION CENTER, BOX 457, 321 NORRISTOWN ROAD, SPRING HOUSE, PA, 19477, US

(21) Appl. No.: 10/400,738

(22) Filed: Mar. 27, 2003

(30) Foreign Application Priority Data
Apr. 12, 2002 (JP) 110312/2002

(51) Int. Cl. B21L 9/00; F16G 13/04

(52) U.S. Cl. 474/213; 474/212; 59/5

(57) ABSTRACT

In a silent chain comprising guide link plates, connecting pins fixed to pin holes of the guide link plates, and toothed inner link plates, and wherein connecting pins fit loosely in the pin holes of the inner link plates, the base material of the inner link plates is an austenite stainless steel, a martensite stainless steel, a precipitation-hardening steel, a high-carbon chromium bearing steel or an alloy tool steel, and is subjected to heat curing. The inner walls of the pin holes are coated with TiN, CrN, DLC, Al₂O₃, Mo, TiAlN, TiC, TiCN, AlN, Si₃N₄, SiC or NiP. The surface of each connecting pin is coated with a metallic hard coating containing at least one element selected from Cr, V, Nb, Ti, Zr, Ta, Mo and W. The base material of the connecting pins and the base material of the inner link plates are different from each other.

### FIELD OF THE INVENTION

This invention relates to silent chains, used for transmitting power in vehicles, industrial machines and the like.

### BACKGROUND OF THE INVENTION

In recent years, silent chains have come into increasing use as timing chains in automobile engines, especially engines designed for use under high speed and high load conditions.

A silent chain comprises guide link plates on the outer sides thereof, interleaved inner link plates, each having meshing teeth, and connecting pins. The connecting pins are fixed to pin holes in the guide link plates, and are loosely fitted in pin holes in the inner link plates. In a silent chain transmission, because the inner link plates make oblique contact with the sprockets, impact due to collision between the sprockets and the chain is relieved, and a low noise level is achieved.

In conventional silent chains, the base material of the connecting pins and the link plates is a chromium-molybdenum alloy steel, or a high carbon steel containing 0.7-1.1% by weight of carbon. These materials are used because of their ready availability and low cost. The surfaces of the connecting pins are subjected to surface treatment, such as carburizing or carburizing-nitriding, to suppress wear of the pins.

In addition to the surface treatment of the connecting pins, it has been proposed, in Japanese laid-open patent publication No. 2000-249196, to subject the link plates to surface hardening treatments such as nitriding or diffusion coating, in order to suppress wear.

However, it has been reported that, in spite of surface treatment of the connecting pins or the link plates, some silent chains fail to exhibit the wear resistance that would be expected as a result of the surface treatment. Overcoming the occasional, unexpected wear, and the resulting wear elongation of these silent chains, had become an a matter of urgency because of the importance of improving the reliability of engines incorporating the chains. After serious study, we have found that the unexpected wear elongation of the chain occurs when lubricating oil in the engine deteriorates. When deterioration of the lubricating oil occurs, oxidation causes its pH to fall to a pH level of 6 or less, and wear of the inner surfaces of the pin holes of the inner link plates is accelerated. We have also found that, when the connecting pin and the inner link plate are composed of the same material, the base materials have a tendency to adhere to each other, causing a further acceleration of wear.

Accordingly, among the objects of the invention are the solution to the above-mentioned problems encountered in the use of conventional silent chains, and the provision of a silent chain which smoothly articulates and slides for a long period of time without generating unexpected wear elongation, even if lubricated by an oil that has become extremely deteriorated.

### SUMMARY OF THE INVENTION

A silent chain according the invention comprising guide link plates, connecting pins fixed to pin holes in the guide link plates, and inner link plates, each having teeth for meshing with sprockets and pin holes in which the connecting pins fit loosely.

In accordance with a first aspect of the invention, the inner link plates comprise a base material composed of steel, selected from the group consisting of an austenite stainless steel, a martensite stainless steel, a precipitation-hardening steel, a high-carbon chromium bearing steel, and an alloy tool steel, wherein the steel base material is subjected to heat curing.

The heat curing process is not particularly limited. Any known heat curing process of the kind usually used for surface curing of steel can be used. However, as is known, different heat curing processes can have different effects, depending on the material to which the process is applied. Therefore, the type of heat curing is preferably selected in accordance with the base materials to be used. For example, a salt bath softening nitriding process known as the Tuftride is suitable for an austenite stainless steel, whereas a carburizing hardening process is more suitable for a martensite stainless steel.

According to another aspect of the invention, a coating is formed on at least the inner wall of the pin hole in each of the inner link plates. The coating comprises at least one material from the group consisting of TiN, CrN, DLC, Al₂O₃, Mo, TiAlN, TiC, TiCN, AlN, Si₃N₄, SiC and NiP. DLC refers to “diamond-like carbon”, an amorphous carbon coating having properties similar to that of diamond.

In a chain in accordance with either of above-described aspects of the invention, each connecting pin is preferably coated with a metallic hard coating containing at least one element selected from the group consisting of Cr, V, Nb, Ti, Zr, Ta, Mo and W. Here, as the metallic hard coating, metallic carbide, metallic nitride, metallic oxide, metallic carbon nitride, and the like can be used. However, for ease of film coating, and affinity for the base material, a coating of metallic carbide is particularly preferred.

In a chain in accordance with any of above-described aspects of the invention, the base material of the connecting pins and the base material of the inner link plates are preferably different from each other.

The use of an austenite stainless steel, a martensite stainless steel, a precipitation-hardening steel, a high-carbon chromium bearing steel or an alloy tool steel, subjected to heat curing, as a base material, and alternatively or concurrently, the use of a coating of TiN, CrN, DLC, Al₂O₃, Mo, TiAlN, TiC, TiCN, AlN, Si₃N₄, SiC and NiP, or combinations of two or more of these materials, enhances oxidation resistance of the inner link plates of the chain so that it can articulate and slide smoothly for a long period of time without exhibiting unexpected wear elongation even in an oxidizing environment caused by deteriorated lubricant.

Oxidation resistance can be further enhanced by coating the surfaces of the connecting pins with a metallic hard coating containing at least one element selected from Cr, V, Nb, Ti, Zr, Ta, Mo and W.

Still further improvements in chain life can be realized by using different materials as the base materials of the inner link plates and the connecting pins, thereby suppressing adhesion between the pins and the plates.

### BRIEF DESCRIPTION OF THE DRAWINGS

FIG. 1 is a perspective view showing a part of a silent chain in accordance with the invention; and

FIG. 2 is a graph showing results of a wear resistance test on the silent chain of the invention.

### DETAILED DESCRIPTION OF THE PREFERRED EMBODIMENTS

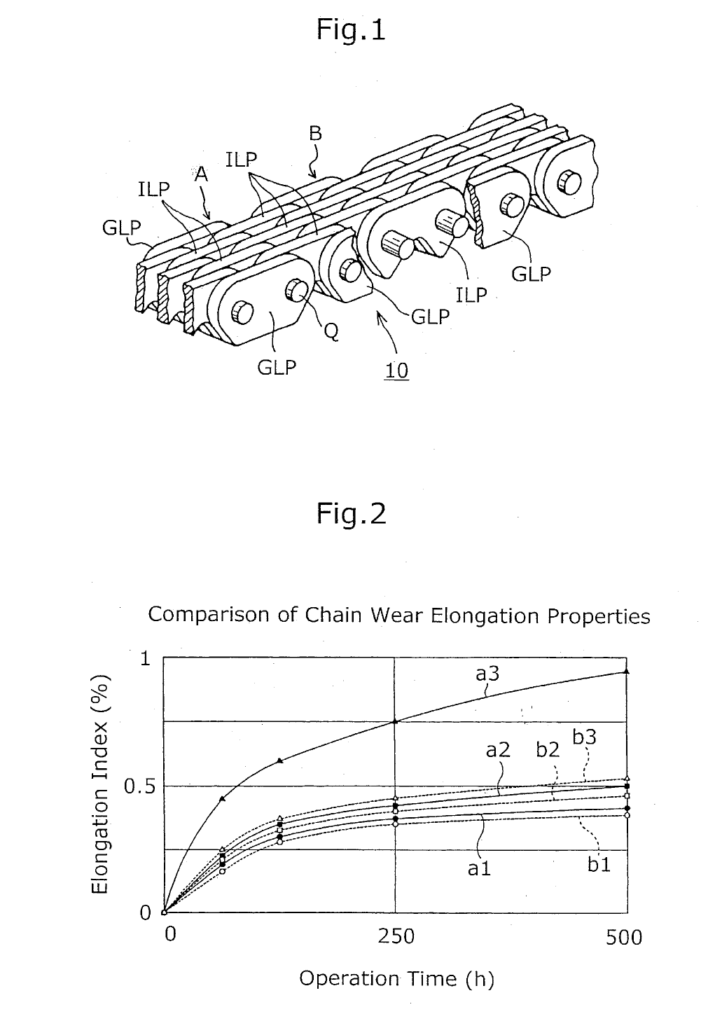

As shown in FIG. 1, the silent chain 10 has joint rows A, each having three inner link plates ILP, and guide rows B, each having two inner link plates ILP, with meshing teeth, and two outer guide link plates GLP. The plates of the joint rows and guide rows are interleaved, and connected by connecting pins Q. The connecting pins are fixed to pin holes of the guide link plates GLP and fit loosely fitted in pin holes in the inner link plate ILP. In FIG. 1 two of the guide link plates GLP on the near side of the chain are shown cut away to reveal one of the three inner link plates ILP of one of the joint rows. FIG. 1 shows an typical example of a silent chain having four plates in each guide row and three inner link plates in each joint row. However, the numbers of the plates in the guide link rows and joint rows can vary, and may be selected depending various factors such as the load to which the chain will be subjected. In general, where the guide link plates are provided on the sides of the chain, the total number of plates in each guide link row will exceed the number of inner link plates in each joint row by one.

In a first example of a chain in accordance with the invention, SUS 304 (18% Cr-8% Ni), which is an austenite stainless steel, was used as the base material of the inner linkplates ILP. The base material was subjected to a salt bath soft-nitriding process known as the Tuftride process.

In a second example, SCM 435, which is a conventional chromium-molybdenum alloy steel, was used as the base material of the inner link plates ILP. The base material was subjected to nickel-phosphorus (NiP) alloy plating by an electroless plating process. In this case, a conventional chromium-molybdenum alloy steel (SCM 435), subjected to a carburizing-nitriding process, was used as the material of connecting pins and the guide link plates.

FIG. 2 shows the results of tests for wear elongation properties in an ordinary lubricating environment, where the pH of the lubricant was 6, and also in an oxidizing lubricant having a pH of 3. The tests were carried out by wrapping a silent chain having a 96 links around two sprockets having 18 and 36 teeth, respectively, rotating the 18 tooth sprocket at 6500 rpm while maintaining tension in the chain at 0.5 kN. The index (%) of elongation of the chains was measured at intervals over an operating time of 500 hours. In FIG. 2, the solid lines a1, a2, and a3 show results, respectively, for silent chains-in accordance with the first and second examples, and a conventional silent chain, when lubricated by an oxidizing lubricant. Broken lines b1, b2 and b3, show results, respectively, for silent chains of the first and second examples, and a conventional silent chain, when lubricated by an ordinary lubricant.

As can be understood from FIG. 2, in the case of an ordinary lubricant, the differences between the elongation indexes for the first and second examples, and the conventional silent chain, are not large. However, in an oxidizing environment, the elongation index of the conventional silent chain is approximately twice that of the same chain in an ordinary lubricant. On the other hand, the elongation indexes of the chains of the first and second examples are almost unchanged. The test results confirm that, even when the lubricating oil is extremely deteriorated, the silent chains of the first and second examples do not exhibit unexpected wear elongation, and articulate and slide smoothly over a long period of time.

Whereas SUS 304, an austenite stainless steel, was used as the material of the inner link plates ILP in the above-described first example, substantially the same results can be obtained with SUS 316, SUS 410, and SUS 440, which are martensite stainless steels, with SUS 630 and SUS 631, which are precipitation-hardening stainless steels, with SUJ2, which is a high-carbon, chromium bearing steel, and with SKD 11, which is an alloy tool steel.

Furthermore, whereas the second example used an inner link plate of conventional base material having a plated coating of nickel-phosphorus (NiP) alloyon its inner surface, substantially the same results can be achieved with TiN, CrN, DLC, Al₂O₃, Mo, TiAlN, TiC, TiCN, AlN, Si₃N₄, or SiC was used as the coating material.

Still further improvements of the wear resistance of a chain in an oxidized lubricant can be realized by forming a coating in accordance with the second example on a surface of a base material in accordance with the first example. In addition to utilizing inner link plates composed of a base material composition of the first example, or a coated base material according to the second example, a metallic hard coating containing at least one element selected from Cr, V, Nb, Ti, Zr, Ta, Mo and W may be formed on the surfaces of the connecting pins. A coating of metallic carbide, metallic nitride, metallic oxide, metallic carbon nitride, or the like, can be used as the metallic hard coating. For ease of formation of the coating, and for affinity for the base material, a metallic carbide coating is particularly preferred. To form these coatings on the surfaces of the pins, well known processes, such as diffusion coating and the like, can be utilized.

When a conventional silent chain is engaged with sprockets, and operated at high speed, and under high load, for a long period of time until the base material of the chain reaches a high temperature, adhesion between the connecting pins and the link plates occurs. However, continuous load tests on the silent chain of the first example have demonstrated that the adhesion phenomenon does not occur. It is assumed that the absence of adhesion in the case of the chain in accordance with the first example is due to the fact the connecting pins and the inner link plates are made of different metallic materials, and the crystal lattice distances in the materials are different from each other, so that diffusion joining at the contact interfaces cannot occur easily. This assumption is supported by the fact that, although the silent chain of the second example cannot endure continuous, long-time, high-speed, heavily loaded, load testing as well as the silent chain of the first example, adhesion can be suppressed as in the case of the first example by forming the base materials of the connecting pin and the inner link plate of metallic materials different from each other.

The advantages of the invention may be briefly summarized as follows.

In accordance with a first aspect of the invention, the base material of the inner link plates, is selected from an austenite stainless steel, a martensite stainless steel, a precipitation-hardening steel, a high-carbon chromium bearing steel and an alloy tool steel, each subjected to heat curing. The use of these base materials improves the oxidation resistance of the inner link plates, suppresses wear elongation of the chain, even in an oxidizing environment.

According to a second aspect of the invention, the inner walls of the pinholes of the inner link plates are coated by a coating comprising at least one material selected from TiN, CrN, DLC, Al₂O₃, Mo, TiAlN, TiC, TiCN, AlN, Si₃N₄, SiC and NiP. This coating also improves oxidation resistance of the inner link plate and suppresses wear elongation of the chain in an oxidizing environment.

According to a third aspect of the invention, when the inner link plates are composed of the aforementioned special base materials, and also when the inner walls of the pinholes are coated, the surfaces of the connecting pins may have a hard metallic coating containing at least one element selected from Cr, V, Nb, Ti, Zr, Ta, Mo and W. This coating affords a still further enhancement in the resistance of the chain to wear elongation in an oxidizing environment.

Additionally, according to still another aspect of the invention, different materials are used as the base material of the connecting pins and the base material of the inner link plates. The use of different base materials suppresses adhesion between the connecting pins and the inner link plates, which can cause wear elongation to develop. The use of different materials makes it possible to avoid wear elongation of the chain in an oxidizing environment over a long period of time.

The invention has significant industrial application because it makes it possible to avoid excessive wear elongation in a silent chain reliably by the selection of base materials and surface treatments of the chain components.

1. A silent chain comprising guide link plates, connecting pins fixed to pin holes in said guide link plates, and inner link plates, each having teeth for meshing with sprockets and pin holes in which said connecting pins fit loosely, wherein said inner link plates comprise a base material composed of steel, selected from the group consisting of an austenite stainless steel, a martensite stainless steel, a precipitation-hardening steel, a high-carbon chromium bearing steel, and an alloy tool steel, and wherein the steel base material is subjected to heat curing.

2. A silent chain comprising guide link plates, connecting pins fixed to pin holes in said guide link plates, and inner link plates, each having teeth for meshing with sprockets and pin holes in which said connecting pins fit loosely, wherein a coating is formed on at least the inner wall of the pin hole in each of said inner link plates, said coating comprising at least one material from the group consisting of TiN, CrN, DLC, Al₂O₃, Mo, TiAlN, TiC, TiCN, AlN, Si₃N₄, SiC and NiP.

3. A silent chain according to claim 1, wherein the surface of each said connecting pin is coated with a metallic hard coating containing at least one element selected from the group consisting of Cr, V, Nb, Ti, Zr, Ta, Mo and W.

4. A silent chain according to claim 2, wherein the surface of each said connecting pin is coated with a metallic hard coating containing at least one element selected from the group consisting of Cr, V, Nb, Ti, Zr, Ta, Mo and W.

5. A silent chain according to claim 1, wherein the base material of said connecting pins and the base material of said inner link plates are different from each other.

6. A silent chain according to claim 2, wherein the base material of said connecting pins and the base material of said inner link plates are different from each other.

7. A silent chain according to claim 3, wherein the base material of said connecting pins and the base material of said inner link plates are different from each other.

8. A silent chain according to claim 4, wherein the base material of said connecting pins and the base material of said inner link plates are different from each other.
